(19) United States
(12) Patent Application Publication
(10) Pub. No.: US 2019/0261636 A1
(43) Pub. Date: Aug. 29, 2019

(54) MOSQUITO REPELLANT

(71) Applicant: SANIT TECHNOLOGIES LLC, Sarasota, FL (US)

(72) Inventor: Joseph GIOVANNIELLO, Wayne, NJ (US)

(21) Appl. No.: 16/319,383

(22) PCT Filed: Jul. 21, 2017
(86) PCT No.: PCT/US17/43215

§ 371 Date: Jan. 21, 2019

Related U.S. Application Data
(60) Provisional application No. 62/364,923, filed on Jul. 21, 2016.

(51) Int. Cl. A01N 65/40; A01N 25/04

(52) U.S. Cl. CPC A01N 65/40; A01N 25/04

(57) ABSTRACT

This application is directed to mosquito repellent formulas and methods of making the same. In one embodiment, a mosquito repellent composition comprises coconut oil and an ionizing agent. In another embodiment, a mosquito repellent composition comprises coconut oil, deionized water, soybean oil, castor oil, sunflower oil, or combinations thereof. Another embodiment is directed to methods of making mosquito repellent spray compositions. Deionized water is directed to a tank. Coconut oil is mixed with the deionized water, and thereafter an ionizing agent is mixed with the contents of the tank. SDA alcohol is mixed with the contents of the tank, and the resultant mixture is mixed with soybean oil. Thereafter, the tank contents are mixed with first castor oil, and then sunflower oil. The contents are then mixed while heated to a temperature of at least 95° F. (35° C.). After mixing, the contents of the tank are cooled, then mixed once more to form a mosquito repellent spray composition.

### RELATED APPLICATIONS

This application claims priority to U.S. Provisional Application No. 62/364,923, filed Jul. 21, 2016.

### TECHNICAL FIELD

This application is directed to mosquito repellant

### BACKGROUND

Mosquitos have been linked to the transmittal of serious diseases and infections. For example, mosquitos have been linked to the spread of serious diseases such as malaria, West Nile virus, dengue, and Zika virus. Mosquitos transmit these diseases through biting their hosts, and are estimated to spread disease to more than 700 million people each year. Approximately two million people die every year of mosquito transmitted diseases.

One of the best ways to prevent mosquito born illness is to avoid mosquito bites, such as through use of insect repellents. Current insect repellents, however, are not always safe. Children and pregnant women, in particular, may experience negative side effects from current insect repellents. Some insect repellant ingredients may cause skin irritations, and, in some rare instances, seizures. There is a need for a safe, natural mosquito repellant that eliminates or reduces the threats caused by mosquitos, while being safely used by people vulnerable to negative side effects in existing repellant products.

### SUMMARY

In one embodiment, a mosquito repellent composition comprises coconut oil and an ionizing agent.

In another embodiment, a mosquito repellent composition comprises coconut oil, deionized water, soybean oil, castor oil, sunflower oil, or combinations thereof.

Another embodiment is directed to methods of making mosquito repellent spray compositions. Deionized water is directed to a tank. Coconut oil is mixed with the deionized water, and thereafter an ionizing agent is mixed with the contents of the tank. SDA alcohol is mixed with the contents of the tank, and the resultant mixture is mixed with soybean oil. Thereafter, the tank contents are mixed with first castor oil, and then sunflower oil. The contents are then mixed while heated to a temperature of at least 95° F. (35° C.). After mixing, the contents of the tank are cooled, then mixed once more to form a mosquito repellent spray composition.

In another embodiment directed to methods of making mosquito repellent gel compositions, coconut oil is directed to a tank, where an ionizing agent is added. The contents of the tank are mixed and heated to a temperature of at least 95° F. (35° C.). After mixing, the contents of the tank are cooled, then transferred to one or more containers. The contents of these containers are then gelled via thickening.

### BRIEF DESCRIPTION OF THE DRAWINGS

FIG. 1 depicts one schematic for the preparation methods described herein.

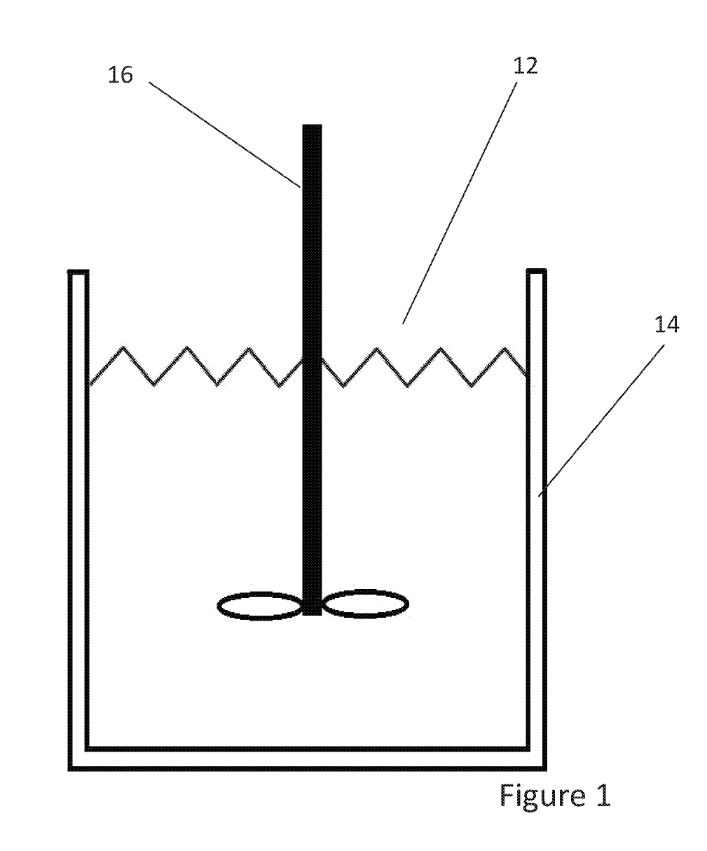

### DETAILED DESCRIPTION

A mosquito repellant composition is comprised of coconut oil and ionizing agent. In a preferred embodiment, the coconut oil is organic, and, more preferably, USDA/NOP certified organic. The ionizing agent may be any agent that provides negative ions. In one embodiment, the ionizing agent is tourmaline. For example, tourmaline products may include white ion powder at a particle size of 0.03 microns sold by Ion Trading Universal Co. in Tokyo, Japan; gray ion powder sold by Ion Trading Universal Co. in Tokyo, Japan; Shanghai Huzheng Nano Technology Co., Ltd.'s negative ion powder; Root's Negative Ion Powder, Type C; and Ion Trading's White Tourmaline Powder (available at www.n-ion.com/e/product/tourmaline-stones-powder/tpd-1-l.html). While these are examples of tourmaline sources, one of skill in the art appreciates that tourmaline sources are not limited to those listed herein; any tourmaline source may be used. Other examples of ionizing agents include gadolinium, phosphorus, samarium, ytterbium, and neodymium. In some embodiment, the ionizing agent is white tourmaline powder. In a preferred embodiment, the ionizing agent is white tourmaline powder with a diameter of 3 microns.

In some embodiments, the repellant formula may further include deionized water. As used herein, deionized water includes water that has less than 1 grain of calcium hardness. Other ingredients may include, but are not limited to soybean oil, castor oil, sunflower oil flavor, SDA Alcohol, and combinations thereof.

In one embodiment, a repellant composition may be created in gel form. One exemplar repellant composition, utilizing this gel form, may be as follows:

TABLE ONE
Components of Repellant Gel Composition

| Component | Amount Present (weight %) |
|---|---|
| Coconut oil | 99.5 |
| Ion Powder | 0.5 |

Other embodiments of gel repellents may further include thickeners. One example of a thickener that may be used with the gel repellents described herein is guar gum. For embodiments containing thickener, the thickener is less than or equal to 0.5% by weight of the repellent. For example, a repellent gel may be comprised of coconut oil (99.0 weight percent), ion powder (0.5 weight percent), and thickener (0.5 weight percent).

In some embodiments, the repellant may be in spray form. By way of example a concentrated spray repellant may comprise the following:

TABLE 2
Components of Repellant Spray Composition

| Component | Amount Present (weight %) |
|---|---|
| Deionized water | 49.3-49.8 |
| Coconut oil | 23.5 |
| Ion Powder | 0.5-1.0 |
| SDA Alcohol | 1.8 |
| Soybean Oil | 10 |
| Castor Oil | 10 |
| Sunflower Oil | 4.4 |

While some embodiments contain ion powder, not all embodiments may contain an ionizing agent. A second exemplar embodiment of a mosquito repellant spray, showing a composition without an ionizing agent, is shown below:

TABLE 3
Components of Repellant Spray Composition

| Component | Amount Present (weight %) |
|---|---|
| Deionized water | 50.3 +/− 3.0 |
| Coconut oil | 23.5 +/− 3.5 |
| SDA Alcohol | 1.8 +/− 1.0 |
| Soybean Oil | 10 +/− 2.0 |
| Castor Oil | 10 +/− 2.0 |
| Sunflower Oil | 4.4 +/− 1.2 |

It may be useful in some embodiments to have an alcohol free repellant. One such exemplar embodiment of a mosquito repellant spray without alcohol is shown below:

TABLE 4
Components of Repellant Spray Composition

| Component | Amount Present (weight %) |
|---|---|
| Deionized water | 52.1 +/− 3.0 |
| Coconut oil | 23.5 +/− 3.5 |
| Soybean Oil | 10 +/− 2.0 |
| Castor Oil | 10 +/− 2.0 |
| Sunflower Oil | 4.4 +/− 1.2 |

In the repellents discussed herein, the particles comprising the repellents possess small sizes. In preferred embodiments, the particles possess diameters that are less than or equal to 1 micron. Studies performed by Applicant demonstrated that smaller particle sizes allow for better adherence of the repellent to skin, leading to longer protection. For example, in one study, smaller particle size showed protection lasting at least four hours after application.

The repellents described herein may be made using the novel methods described herein. Indeed, testing has shown that manufacturing the repellents using these methods increases the ability of these compositions to repel mosquitos.

To manufacture a gel or spray repellant composition, the amounts of each component to be added is determined. Because the amounts of each component are dependent on the size of the batch to be prepared, these amounts may be calculated using the weight percentages shown herein for a particular batch. In some instances, the size of the vessel being utilized in these methods may be determinative of the amount of ingredients to be used. Although in some embodiments, the amounts of all components may be calculated prior to the first components being added together, one of skill in the art appreciates that the appropriate amount of a given ingredient may be calculated at any time prior to the inclusion of that ingredient into the concentrated sanitizer solution.

The repellant compositions may be prepared in a mixing tank 12. A heat source may be applied to the mixing tank. Any source appropriate for heating a tank or other liquid-containing vessel may be utilized. In some embodiments, the mixing tank is a heated jacket style tank, and includes a heating jacket 14 as the heat source. The mixing tank further includes a mixer 16. The mixer is a high speed mixer and, in some embodiments, includes a speed control. The mixer 16 may be any style mixer that allows particle sizes of components to be reduced to less than 1 micron in diameter.

In a preferred embodiment, the mixer 16 is a shear style mixer. The mixer may be used with a baffle plate. One such mixer that may be utilized is a Hill type mixer. By varying the degree of the blade in the mixer, one may control the size of the particle. For example, if a particle size of 1 micron is desired, the blade should be set at 45 degrees. By way of another example, a blade set at 15 degrees results in a particle size of 0.05 microns.

Mixing time may be dependent on the amount of a mixing vortex created by the mixer. The mixers identified above create these vortexes, which aid in grinding particles and decreasing the particle size. An increase in the speed of the mixer increases the amount of vortex generated and decreases the time to grind the particles. For example, in some embodiments using the Hill mixers described herein, mixing may occur using a rear stat to control the speed to between 2500 rpm mixing and 10,000 rpm.

To prepare a repellant formula in gel form, coconut oil is added to the mixing tank, followed by the ionizing agent. In some embodiments, a thickener is also added. The contents of the mixing tank are heated to at least 95° F. (35° C.) while mixing. Preferably, the contents of the mixing tank are heated to between (and including) 95° F. (35° C.) and 115° F. (46° C.). The mixing is done in such a way as to sheer the particles of the ingredients, resulting in particles with diameters of less than or equal to 1 micron. In a preferred embodiment, the contents of the mixing tank are mixed for approximately three hours. After mixing, the contents of the mixing tank are cooled to room temperature. In one embodiment, the contents are cooled for approximately two hours. After cooling, the mixture from the mixing tank is drained into containers. The mixture in the containers is allowed to sit and thicken, forming a gel.

To prepare a repellant formula in spray form, deionized water is placed into the mixing tank. In some embodiments, the water is at room temperature. Coconut oil is added to the water in the mixing tank. The contents of the mixing tank are mixed for approximately ten minutes. Soybean oil is added to the contents of the mixing tank. The contents are again mixed for ten minutes. Following this mixing, castor oil is added to the mixing tank and the contents mixed once more. Thereafter, sunflower oil flavor is added. In some embodiments, SDA alcohol and/or an ionizing agent are also added. After each addition, mixing occurs for ten minutes. One of skill in the art appreciates that the addition of these ingredients may come in any order.

The contents of the tank are heated to at least 95° F. (35° C.) and are thoroughly mixed. Preferably, the contents of the mixing tank are heated to between (and including) 95° F. (35° C.) and 115° F. (46° C.). In a preferred embodiment, the contents of the mixing tank are mixed for approximately three hours after the addition of the final ingredient. The mixing is done in such a way as to sheer the particles of the ingredients, resulting in particles with diameters of less than 1 micron. After mixing, the contents of the mixing tank are cooled to room temperature. In one embodiment, the contents are cooled for approximately two hours. After cooling, the mixture is mixed again, and then drained into containers.

Laboratory tests were performed using the repellant formulations disclosed in herein. In control tests, mosquitos fed upon test hosts. When the formulations disclosed herein were applied to test hosts, it was discovered that mosquitos ceased feeding on test hosts and attempted to place distance between themselves and the test hosts.

In one test, yellow fever mosquitos (Aedes aegypti) were observed to determine the average number of landings and probes over a two hour period before application of the mosquito repellant formulations discussed herein and over a two hour period after application. The control samples saw a slight increase of mosquito activity between the before and after application. After application of the formulations described herein to the samples, a reduction of 93% in mosquitos landing on samples and a reduction of 100% in mosquitos probing samples was observed.

Although the present composition has been shown and described in considerable detail with respect to only a few/particular exemplary embodiments thereof, it should be understood by those skilled in the art that it is not intended to limit the composition to the embodiments since various modifications, omissions, and additions may be made to the disclosed embodiments without materially departing from the novel teachings and advantages of the composition, particularly in light of the foregoing teachings.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A mosquito repellent composition comprising coconut oil and an ionizing agent.

2. The mosquito repellent composition of claim 1, further comprising deionized water, soybean oil, castor oil, sunflower oil, or combinations thereof.

3. The mosquito repellant composition of claim 2, further comprising SDA alcohol.

4. The mosquito repellant composition of claim 1, further comprising a thickener.

5. The mosquito repellant composition of claim 4, wherein the thickener is guar gum.

6. A mosquito repellent composition comprising coconut oil, deionized water, soybean oil, castor oil, sunflower oil, or combinations thereof.

7. The mosquito repellent composition of claim 6, further comprising SDA alcohol.

8. A method of making a mosquito repellent spray composition, comprising:
directing deionized water to a tank;
mixing coconut oil with the deionized oil in the tank;
mixing soybean oil with the contents of the tank;
mixing castor oil with the contents of the tank;
adding sunflower oil to the contents of the tank;
mixing the contents of the tank, wherein the contents of the tank are heated to a temperature of at least 95° F. while mixing;
after mixing, cooling the contents of the tank; and
after cooling the contents of the tank, mixing the contents of the tank to form a mosquito repellent spray composition,
wherein mixing reduces the particle sizes of the deionized water, coconut oil, ionizing agent, SDA alcohol, soybean oil, castor oil, and sunflower oil particles to particles with diameters less than or equal to 1 micron.

9. The method of claim 8, further comprising mixing SDA alcohol with the contents of the tank.

10. The method of claim 8, further comprising mixing an ionizing agent with the contents of the tank.

11. The method of claim 8, further comprising mixing an ionizing agent and mixing SCA alcohol with the contents of the tank.

12. A method of forming a mosquito repellent gel composition, the method comprising:
directing coconut oil to a tank;
directing an ionizing agent into the tank;
mixing the contents of the tank and reducing the particle size of the coconut oil and ionizing agent particles to particles with diameters of less than or equal to 1 micron, wherein the contents of the tank are heated to a temperature of at least 95° F. while mixing;
after mixing, cooling the contents of the tank;
transferring the contents of the tank to one or more containers;
gelling the contents of the one or more containers to form the mosquito repellent gel composition by allowing the contents to thicken.

13. The method of claim 12, further comprising directing a thickener into the tank and mixing the thickener with the coconut oil and ionizing agent.
